(19) United States
(12) Patent Application Publication
(10) Pub. No.: US 2024/0054017 A1
(43) Pub. Date: Feb. 15, 2024

(54) NEAR REAL TIME REQUEST HANDLING IN FLEXIBLE API ROUTER

(71) Applicant: Shabodi Corp., Toronto (CA)

(72) Inventors: Mehdi Jafarizadeh, Hamilton (CA); Nitin Sood, Mississauga (CA); Harpreeet Geekee, Oakville (CA)

(21) Appl. No.: 18/232,669

(22) Filed: Aug. 10, 2023

Related U.S. Application Data
(60) Provisional application No. 63/396,738, filed on Aug. 10, 2022.

(51) Int. Cl. G06F 9/50

(52) U.S. Cl. CPC G06F 9/5016

(57) ABSTRACT

In an API Router for use in a real-time or near real-time network environment a method of processing an inbound request at a messaging router within a software defined network, by receiving the inbound request at a defined interface, assigning the inbound request to an active thread, transmitting a response to the inbound request, generating an outbound request for transmission into a software defined network in accordance with the received inbound request using the active thread, transmitting a generated outbound request to a node within the software defined network determined in accordance with the inbound request and a priori knowledge of a topology of the software defined network, and tracking a state of the connection using a directed acyclic group state machine.

### CROSS REFERENCE TO RELATED APPLICATIONS

This application claims the benefit of U.S. Provisional Patent Application 63/396,738 filed 10 Aug. 2022; which is incorporated herein by reference for all purposes.

### TECHNICAL FIELD

This application relates generally to an Application Programming Interface (API) Router, and more particularly to an API Router for use in a real-time or near real-time network environment.

### BACKGROUND

As fifth generation wireless networks, based on standards promulgated by the Third Generation Partnership Project (3GPP), are deployed applications resident within the 5G core network (CN) or within a network such as an edge network (EN) trusted by the network operator, are able to exchange information with network functions (NFs) within the 5G Control Plane (CP). This information exchange allows the CP NFs to define Quality of Service (QoS) parameters for connections between the user equipment (UE) and User Plane (UP) application function (AF) in question.

Applications resident outside the 5G CN, are typically not provided the same ability to influence the traffic handling of data flows. In some specific situations, the Application Server (AS) on which an Application Function (AF) outside the CN is executed can have a specific arrangement with a network operator to allow the AF or AS to transmit requests to influence traffic handling to 5G CP NFs. These arrangements typically require that the AS/AF be approved and trusted by the network operator, and that the AS/AF be provided information about the 5G network architecture so that requests for session handling can be made taking the available 5G network resources into account. As the 5G network architecture is designed with the notion of a dynamic and flexible network making use of virtualization to provide CP NFs and UP AFs on an as-needed basis, and with variable network resource allocations for each NF and AF, an AF/AS outside the CN is likely to be unable to take advantage of dynamic changes in the network topology. Instead, an AS outside the CN will typically be informed of a static 5G network architecture, so that its requests for resource allocations are based on resources that do not typically change over time.

In previously filed U.S. Provisional Patent Applications 63/231,837 entitled “System and Method of Integrating Standard and non-Standard Network Services” filed Aug. 11, 2021 and 63/325,241 entitled “Network Element and Service Discovery” filed Mar. 30, 2022, an application definition function (ADF) is introduced that can act as a trusted entity within a 5G network, but also allows a plurality of different AFs/ASs outside the 5G CN to take advantage of the dynamic resource allocations of a 5G network. The ADF receives requests from an AS through a single application facing/Northbound API. Based on the particular network that the request is associated with, the ADF generates a set of network specific requests according to an API provided by a particular 5G network operator. This allows an application developer to focus on building features in the application without having to customize an application-network interface for each different network through which the AS is accessed. A similar benefit is realized by 5G network operators who can reduce the number of partnerships that they have to enter into with application providers, thus reducing the number of entities that are provided access to 5G CP NFs, thus reducing the likelihood of a security issue.

In this translation process, the ADF may be considered to be acting like an API Proxy, or API Gateway, in that it receives a request formatted according to requests and parameters defined by an application facing API, and based on the received request and resources available in identified networks, generates a set of outbound requests according to the API defined by the identified network(s). Based on responses received in accordance with transmitted outbound requests, a set of responses is generated and transmitted to the requesting AS.

There are a number of different known API gateways, including Krakend (http://wvw.krakend.io), as well as Kong (https://konghq.com) and NGINX (https://www.nglnx.com). These API Gateway services act upon requests received from applications formatted according to a published API. Based on a number of different factors, the received requests are translated into requests for different web based services, such as authentication, caching, filtering, load balancing, throttling and QoS monitoring. The architectures of these API Gateway services are largely based on the need to support web-based applications such as e-commerce. Telecom level reliability and speed of responses are thus designed to support non-real time service standards. Conventional API Gateways typically lack the robustness, speed and flexibility to work with dynamic networks such as 5G Core Networks, Edge Networks and RANs, along with other Software Defined Networks (SDNs) that may be used in a range of environments including telecommunications.

These API Gateway services are typically designed around the use of a finite state machine to track the current, and possible future, states of a given connection. Between each defined state is a transition that is often associated with a request or a response, either of which can serve as a cue for a transition between states. The use of a finite state machine allows the API Gateway to model each connection as having a set of possible next states that are defined in advance, allowing for a transition between states to be ordered and relatively fast.

### SUMMARY

However, the defined number of states to which a transition is available cannot properly support the dynamic nature of 5G network or other dynamic software defined networks. As the number of available nodes changes, and as the resources available to an existing node or function in the 5G network is increased or decreased, the number of possible states that the connection can move to changes. To maintain the use of a finite state machine, as used in conventional API gateways, the available network resources will typically be restrained, or the set of next states needs to be updated dynamically. As the number of applications making use of the API gateway increases, and as the dynamicity of the networks to which the applications have access increases, the use of a finite state machine to track the state of different connections becomes a burdensome task that cannot be performed in near-real time.

An API Gateway or Proxy that can intelligently handle both a variety of different applications making requests, and a dynamic number of underlying network resources across a number of different network providers, each of which may provide a changing network, is beneficial for supporting applications accessing 5G networks. Similarly, moving from a so-called webscale response time to a telecom grade response time is important. Where delays on the order of 1 second are not exceptional in an ecommerce environment, these delays during initiation of a connection and during the modification of the parameters of a connection in a telecommunications network environment are considered to be too long. Reducing these delays cannot simply be accomplished by allocating more computing or memory resources to the API Gateway. Allocating increased resources may temporarily offer solutions, but is not considered a scalable solution. Additionally, some of the conventional API Gateway architectures are not designed to operate within real time and near real-time timeframes as is required in a telecommunications network environment.

It is an object of the aspects of the present disclosure to obviate or mitigate the problems described above.

In a first aspect described in the present disclosure, there is provided a method of processing an inbound request at a messaging router within a software defined network, the method comprising receiving the inbound request at a defined interface; assigning the inbound request to an active thread; transmitting a response to the inbound request; generating an outbound request, for transmission into a software defined network, in accordance with the received inbound request using the active thread; transmitting generated outbound request to a node within the software defined network determined in accordance with the inbound request and a priori knowledge of a topology of the software defined network; and tracking a state of the connection using a directed acyclic group state machine.

In an embodiment of the first aspect the method further comprises receiving a response to the transmitted request; and generating a secondary request for transmission to a second node within the software defined network, both the second node and secondary request determined in accordance with the inbound request, the tracked state, and the received response. In a further embodiment, the method further comprises generating and transmitting an updated response to the inbound request in accordance with the received response.

In another embodiment, the step of generating an outbound request comprises generating a set of outbound requests in accordance with the received inbound request.

### BRIEF DESCRIPTION OF THE DRAWINGS

Embodiments of the present invention will now be described in further detail by way of example only with reference to the accompanying figures in which:

FIG. 1 is an illustration of a block diagram of an API Router in accordance with an embodiment of the present disclosure.

FIG. 2 is an illustration of a plurality of API Routers in a first network and a second network in accordance with an embodiment of the present disclosure.

FIG. 3 is an illustration of a communication process between a network aware application, an API Router and an advanced network according to an embodiment of the present invention.

In the above described figures like elements have been described with like numbers where possible.

### DETAILED DESCRIPTION

In the instant description, and in the accompanying figures, reference to parameters may be made. These parameters are provided for the enablement of a single embodiment and should not be considered to be limiting or essential. It should be understood that the parameters discussed below are used for the sake of explaining an embodiment. It is not intended to convey either that particular parameters are essential, nor is the following discussion intended to be exhaustive in discussing the parameters upon which the Application Definition Function will operate.

Software Defined Networking (SDN) and virtualized computing have been areas of focus in computer networks. Together they allow for a set of network functions to be instantiated on network nodes so that each function is distinct from other functions, even when they are instantiated on the same physical node. Virtualization also allows for the resources allocated to a single virtualized entity to be expanded and contracted on an as-needed basis. These resources can span across multiple physical nodes, and should be understood to include processing resources, memory and other storage resources, as well as networking resources.

In a data center, virtual nodes can be created, connected to each other, and have the computing, storage and network resources adjusted both upwards and downwards over time.

In data networks, virtualization and SDN have transformed the manner in which historically static network resources are used. Resource allocation can be adjusted to accommodate demand, while the connection between nodes can be adjusted in accordance with data traffic and network administration needs.

In many SDN networks, such as those used for mobile networks core networks (including 5G networks), network architectures have been designed to allow a strictly defined set of connections between nodes. In a network with 12 network nodes or functions, there are 60 different possible connection paths between these nodes. This number of connections expands quickly as the number of nodes increases. Even with the flexibility of SDN, managing these connections can be difficult to manage. For purposes of both security and ease of administration, in many SDN-based networks, network functions are designed to only communicate with a limited number of other network functions. This avoids needing to design a network in which the number of possible connections balloons exponentially as new nodes are introduced. This introduces a problem of filtering inbound connections at different nodes to ensure that the other side of the connection is acting appropriately. In the model used in a 5G core network, communication between different network functions is carried out using defined network interfaces. These interfaces allow for only a subset of the network functions to communicate with each other.

Other network configurations, such as those in which a plurality of nodes are each to a central node which acts as to route or switch data flows, are not typically used with networks of any scale or speed due to the limited ability of such central nodes to act to route messages sufficiently quickly. This is a similar problem to that outlined above with respect to API Routers. Network architectures have been adapted to avoid these issues by avoiding the use of nodes that can act to switch or route messages on behalf of other nodes. Despite this, there remain many advantages to being able to create a switching node that can route messages quickly enough to allow for use within a telecommunications networks.

The following embodiments will largely be directed towards the use of an API Router in the context of a telecommunications network, such as a 5G core network. It should be readily understood that this is solely for the purposes of a consistent example. The API Router discussed herein is a single example of a node that can switch or route messages between nodes, and can carry out translation or other such activities. In some embodiments, this can form the basis of an Application Description Function in a 5G core network. In other embodiments, this can form the basis of a node that carries out routing or switching of message flows between nodes in a Software Defined Network. Other embodiments that would be apparent to those skilled in the art, unless explicitly described as such, are not intended to be excluded.

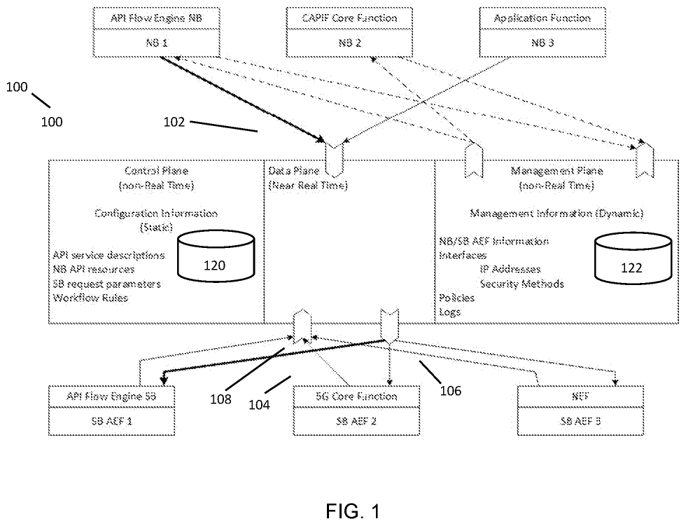

In the following discussion, an Application Programming Interface (API) Router, as shown in FIG. 1, will be discussed. It should be understood that the terms API Router, API Gateway and API Proxy are each used in a somewhat overlapping fashion in the art. The API Router 100 discussed herein makes use of a so-called Northbound Interface 102 through which an Application Server (AS) can transmit requests and through which responses to the received requests can be transmitted. At a southbound interface 104, an API invocation interface 106 allows the API Router 100 to transmit requests to networks. The API invocation interface 106 can make use of exposure functions embedded in the different networks to discover and access their APIs. The Southbound interface 104 also makes use of a response interface 108 through which it receives responses to the requests transmitted through the API invocation interface 106. It should be understood that the northbound interface 102 can support bidirectional communications with application servers typically through a northbound interface module specific to the entity with which it is associated.

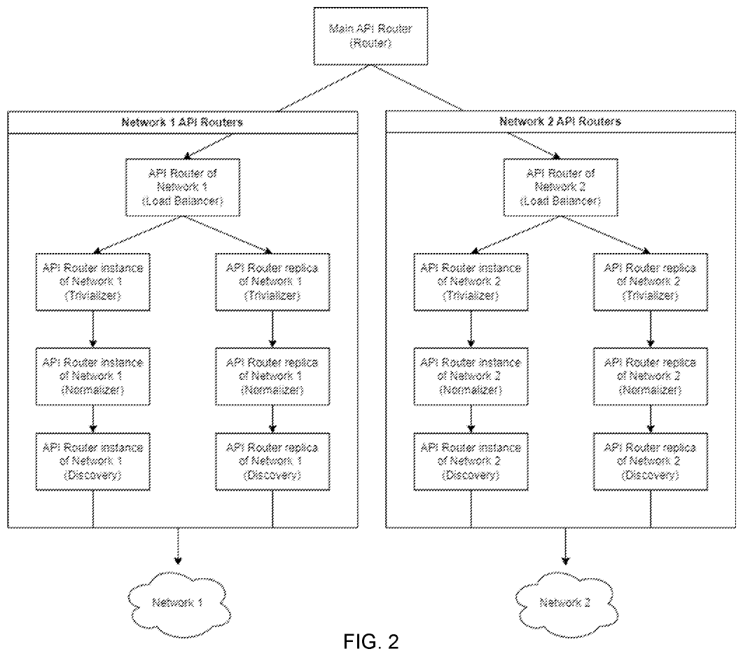

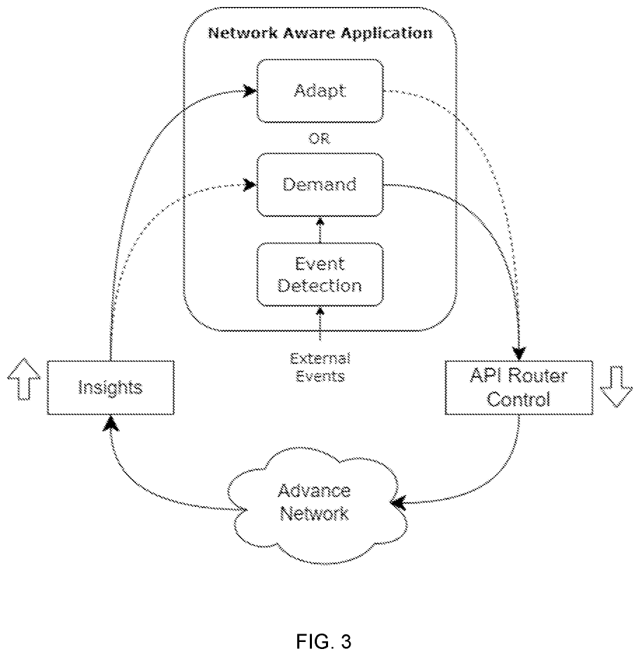

It should also be understood that the innovative use of techniques and methods discussed herein can allow for the deployment of an API Router that can operate in near real-time with a non-static network such as any one or more of a 5G Core Network, a 5G Radio Access Network, as well as other communication networks such as those designed to support large scale WiFi deployments. An API Router using the techniques disclosed below can also provide flexibility to allow for supporting a dynamic network such as an SDN, while hiding the related complexity from the requesting application. Although discussion below will focus on the use of a near real time (or real time) API Router in the context of telecommunications network use cases, it should be understood that the novel and innovative techniques discussed herein can be employed in any number of different environments to provide benefits including those related to speed, performance and a reduction in processing or resource overhead. For example, the techniques described herein can be used in a system encompassing a plurality of networks having a plurality of API Routers, as shown in FIG. 2. The flexibility of the API Router to support access to dynamic networks can be used with both dynamic and static networks. The flexibility of an API Router to manage states that are not defined either at the start of a transaction, or at the time of publishing the public facing API, can allow for the addition of new networks, not just new network resources, without requiring that the requesting AF/AS be made aware of the new resources. This can be accomplished as shown in FIG. 3

The API Router has a public facing API that is published so that outside entities can obtain the supported set of requests and parameters. An entity outside the network can then transmit a request to the API Router using the public facing API. The API Router can then translate the received requests to a number of different API calls specific to the network. This allows QoS and Quality of Experience (QoE) requests to be transmitted to NFs within the networks that will carry traffic between the UE and AS on behalf of the entity that transmitted the original requests. Other types of API calls may include registration calls, as well as data transmission and retrieval calls.

The API Router (also referred to as an NF API Router) can model each connection that it creates using a state machine based on a Directed Acyclic Graph (DAG) instead of the FSM as used in the prior art. A DAG allows for the definition of states, and the connection between states, to be dynamic. This allows the API Router to support SDN and other dynamic networks as the network carrying traffic between the user equipment and the AS. Where an FSM may not be able to adjust to dynamically changing network resources, a DAG can support the dynamic nature of SDN networks providing greater flexibility in the API Router. This additional flexibility can provide performance advantages as it does not need to model a number of different states and transitions from each of the states. Implementation of such a DAG will thus address some of the issues associated with existing API gateways not being able to support dynamic network resources that may be added or removed between the start and end of a transaction. Redesigning the possible states that can be transitioned to by an FSM, during a given transaction may result in an FSM that cannot respond quickly enough to a request received on a northbound interface. The flexibility provided through the use of a DAG can address these concerns in the near-real time environments associated with telecommunications networks.

When a transition between states is carried out, the set of possible next states can be computed. This set of next possible states may be updated periodically, so that when a transition to another state is required, the set of available destination states is sufficiently up-to-date that it does not necessarily need to be recomputed, which can allow for reduced computational handling at transition time. Through the use of a DAG-based state machine, the NF API Router reduces the complexity associated with the use of a state machine in an environment which allows for an increase in the speed at which it is able to operate.

With regard to the illustrated example, as shown in FIG. 1, of the NF API Router 100, it should be noted that the Northbound Interface 102, through which AF/AS requests are received, is not the only source of information that can be used to influence the creation of requests transmitted through the southbound interface 104. In some cases, these southbound requests may include the generation of QoS requests and associated traffic treatment protocols.

The illustrated southbound interface 104 has a pair of data plane interfaces 110, 112, an API invocation interface 106 and a Response interface 108. Typically the API invocation interface 106 is used to transmit requests that have been generated by the NF API Router 100 to a flow engine, or other communication network function. Often, these requests are based on a request received at the northbound interface 102, the network specified in the received request and other information that may be internally held or cached by the NF API Router 100. To provide faster handling of these requests, the NF API Router 100 can operate in an asynchronous manner, so that generated request are transmitted through the API Invocation interface 106 to the corresponding network interface. The response to these requests is not always instantaneous. Some telecom networks refrain from sending a response to a received request until the end of an acceptable time window. This makes timely processing of such responses difficult if the acceptable time window is to be respected. Accordingly, the NF API Router 100 may generate a response to a received reply, and may transmit the generated response before a response to the generated request is received. The state of the session is tracked by the NF API Router 100 through both a session ID and an identifier of the state of the DAG-based state machine.

In the time interval between the transmission of a request to create a session and the receipt of a reply through the southbound interface, the session in question does not necessarily need to be held open (if it was not originally open). Instead, the session ID can be maintained in a table with information including session end points and other identifying information. The request can be transmitted with an identifier of the session ID that will be included in the response. When the response is received, the response and session ID allow for an identification of the DAG state associated with the session. This information can be used as a pointer to allow for a dormant or inactive DAG based state machine to be activated with the correct state. It should be understood that in many instances, although a request may be issued with a set of parameters for the session, it may not always be possible for the network to provide the requested resources. The parameters for the session help in determining the state of the DAG based state machine, and thus, the state of the session can be thought of as indeterminate until the response is received.

The NF API Router 100 may, in some situations, be able to predict with a high degree of certainty what a response may indicate. This may be supported through the use of machine learning and information about the previous and current network loading conditions. In such a situation, the session DAG-based state machine may be set to an expected state to reduce time associated with activation of the state machine. In other situations, the state machine is not activated, and instead a set of pointers to different possible states are stored in relation to the session ID. When a response is received, an active state machine can either be transitioned to the correct state, or, an inactive or dormant state machine can be launched with a pointer so that it launches into the correct state.

This allows for the state machine to be rapidly set to the correct state for a given session, while reducing the temporal overhead that is commonly incurred with FSMs and other session creation techniques. A state machine associated with the session does not necessarily need to be active when the session itself cannot receive traffic, thus, even if the session ID is provided to the AS through the northbound interface in a response before a response is received from the underlying network over the southbound interface, the state machines doesn't need to be active as the session is not formally established.

When the NF API Router 100 receives an inbound (IB) request, the request can be parsed to identify information that is used to generate an outbound (OB) request. It should be understood that the responses to OB requests, which would typically be received through the southbound interface, can also act as inputs in the generation of secondary and tertiary outbound requests.

The logical separation of the southbound interfaces allow the API Router 100 to operate without necessarily generating the requests in a format particular to a given destination network. Instead, the API invocation can be governed by both the inbound request (or inbound response) along with policy information governed by the management and control plane functions of the API Router 100. This policy-based information can be processed to determine how the API invocation will happen, and how the generated requests will be formatted and transmitted. The updating of the configuration of these policy based rules can be handled at times of low or no traffic or when there is no active session associated with the policy. This reduces the likelihood of collisions and contention.

The above described session creation and state modeling allows for a reduction in the overhead and processing associated with standing up a session in the underlying network. This effectively pipelines steps so that as much of the session initiation and management is parallelized. By determining the possible states in advance of receipt of a final response to the session initialization requests, the session initiation can be handled quickly so that the near-real time requirements of telecommunications networks are accommodated.

In mapping the requests and parameters of inbound requests and responses to the requests and parameters of outbound requests, workflow rules and policies stored within the NF API Router 100 are typically followed, which may govern how requests are built. This allows similar request from different Applications to be handled differently, whether they are associated with the same underlying network or not. To allow the API invocation to occur at near real time (along with the corresponding mapping of inbound requests and parameters to outbound requests and parameters) updates to the configurations can be delayed so that the updates can be performed when the session is not active. This allows for reduced handling time and reduced processing overhead associated with the initiation of a session.

Information associated with the invocation of sessions may be held in one or more databases to allow for near-real time processing. In one embodiment, a Configuration Database 120 is used along with a Management Database 122. The Configuration Database 120 can be used to house data that would be the same for multiple instances of the API Flow engines with the same type. This may entail API configuration data along with parameter mappings and workflow rules. This data can be fed by a configuration framework in the control plane. The Management Database 122 includes data that changes from one deployed instance to another. This may include policy based rules, AEF configurations and logs. This data may have multiple sources including manual or automated updates from AS customers, the NF API Router operator or through an automated API discovery endpoint within the NF API Router 100.

To further support a Near-Realtime operation of the NF API Router 100, the API Router 100 can be designed to following the following objectives:
Request processing can be performed in parallel and asynchronously
Runtime variables can be stored in RAM wherever possible
Horizontal extendibility should be a design objective
Requests and connection establishment should be handled in existing threads instead of requiring the creation of new threads
Transformation time (e.g. the time between receiving a request at the northbound interface and the transmission of a first associated request from the southbound interface) should be bounded at high side
An application function or server communicating with the northbound interface should receive a status update after associated southbound interface calls.

The parallelization and asynchronous handling of requests has been discussed above, but in addition to these points, other handling techniques can be used. Active processing threads can be maintained within the API Router 100 when no request to be processed by the thread has been received. Thus, at any time there can be otherwise active threads already instantiated ready to be assigned to the processing of an inbound request. When a request is received, it can be associated with a thread, without requiring the thread to be initialized. When the processing of a thread has been completed, the thread can remain active and awaiting the assignment of a new request. This effectively creates a pool of persistent active threads that have not been assigned to inbound requests. The immediate availability of a processing thread to handle an inbound request can effectively reduce the time that a received request remains unprocessed within the API Router 100. In some embodiments, the threads may be instantiated but allowed to transition into an idle state, which may reduce the resources associated with maintaining a set of active threads that are not currently being used to process a request. In some embodiments, a minimum number of active threads are maintained, with other threads being kept in an idle state that consumes fewer resources.

Although in the above described embodiments, persistent threads are described, it should be understood that it may be possible to terminate threads after they have completed processing a request, so long as there remains an adequate number of active threads. In some embodiments, threads can be terminated and re-initiated so that they are not properly persistent. Thus, with an predefined number of active threads, a request received over the northbound interface can be mapped to an available thread without the need to buffer the request until an active thread can be initialized. When a response to a southbound request is received, it can be handled by an already initialized thread so that modification of the state of the connection or so that communication with the AF/AS through the northbound interface can be performed without requiring that the request necessarily be buffered. When an active thread exists and is not associated with an existing request, the thread can be assigned a new request. Threads should be assigned to any request that has been received to avoid having to queue or buffer requests where possible. Thus, all active requests should be handled by parallel connections wherever possible.

By storing runtime variables in active memory, Input/Output procedures can be avoided which will reduce processing time by avoiding the wait states associated with I/O procedures accessing slower storage. In systems with a plurality of different memory levels, the runtime variables may be stored outside active memory, but still in a memory that is sufficiently fast to allow for I/O wait states to be avoided.

The extendibility of the system horizontally allows for the NF API Router 100 to increase the number of threads used to manage connections. By designing the NF API Router 100 to be based on Software Designed Networking resources, a virtual machine or container associated with the NF API Router 100 can be assigned additional computing networking and storage resources so that the number of threads can be dynamically increased to respond to an influx of new requests. Although a second NF API Router could be created to allow for load balancing, the ability of an existing NF API Router to be horizontally extendable can avoid the overhead and complexity of instantiation of a second NF API Router and the load balancing management it would require.

As noted above, it may be beneficial to handle each request in a dedicated thread. This thread is preferably already instantiated and active, so that a request can be assigned to a thread as it arrives, avoiding the overhead of creating a new API Router thread to handle a new connection or a new configuration request. The overhead of idle threads is one that can be addressed by the allocation of computing and memory resources. The commensurate reduction in the overhead as it relates to latency is typically considered to be a beneficial tradeoff when real-time, or near real-time, processing of requests is a requirement.

The bound on the upper end of the transformation time is an objective that can be reached through the judicious allocation of resources with the other recited objectives. In some examples the upper bound may be set so that the transformation deadline is <0.1 ms. This allows for a sufficiently near real-time processing while remaining achievable. Lower transformation deadline upper bounds may be achieved but at the cost of a disproportionate allocation of resources, while higher upper bounds may not satisfy the near real-time requirements of interacting with standardized telecommunications networks.

By issuing a status update after each request sent from the SB interface, the API Router reduces the waiting time of a requesting AS. As responses are received, an updated status can be pushed to the AS through the NB Interface. If implemented using an HTTP/HTTPS interface, the push update can be sent in response to a predefined communication path using persistent websocket connections.

Through the use of the above techniques, it is possible to design an API Router for use in a near real-time telecommunication network environment. Although one of the requisite factors is the deployment of sufficient computing, storage and networking resources, this alone is not sufficient to allow for deployment of an API Router working in near real-time (unless massive over engineering of the API Router is acceptable). The techniques of parallelization, proactive generation of connection threads, and the use of a DAG-based state machine allow for the tasks associated with the creation of new connections and the updating of the parameters of an existing connection to be broken down into effectively elemental tasks. Each of these elemental tasks can be performed in parallel, and where necessary if there are a plurality of likely outcomes, pipelining techniques can be used to proactively follow likely paths. The devolving of a single task into a set of elemental tasks allows for the asynchronous handling of different parts of the task in a pipelined fashion. This allows for the API Router to take advantage of a proctor based design using asynchronous processing and completion handling. This allows for the API Router to not just process a request, but to anticipate the response of the underlying network and to set pointers to likely states of the DAG based state machines. When a response is received, additional requests may be issued, but the DAG can be activated in the correct state without the API Router having to keep a very complex FSM running.

In some embodiments, it may be determined that an inbound request can be devolved into a series of smaller tasks. In some cases, there may be different sets of smaller tasks that could be arranged into different branches, making the execution of some branches dependent upon a response to an earlier task. These tasks, and the varying branches of tasks can be queued on a stack (such as a last-in-first-out queue). As tasks are executed, new tasks can be created and pushed on the existing stack. This can allow for atomization of inbound requests into a series of tasks that can be carried out in sequence. When there is information required to complete a task, the retrieval of that information can be treated as a new task that is then pushed onto the stack. By addressing the tasks on the stack in a last-in-first-out order, all the information required to fully form outbound requests can be obtained, and different possible branches can be avoided without having to transmit requests associated with unselected branches.

Various embodiments of the present disclosure may be implemented in a data processing system suitable for storing and/or executing program code that includes at least one processor, including a multicore processor, coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language, “R” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

As used herein, the term “about” and/or “substantially” refers to a +/−10% variation from the nominal value/term. Such variation is always included in any given.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

1. A method, comprising:
receiving an inbound request at a defined interface of a messaging router within a software defined network;
assigning the inbound request to an active thread;
transmitting a response to the inbound request;
generating an outbound request, for transmission into a software defined network, in accordance with the received inbound request using the active thread;
transmitting the generated outbound request to a node within the software defined network determined in accordance with the inbound request and a priori knowledge of a topology of the software defined network; and
tracking a state of the connection using a directed acyclic group state machine; and
allocating computing and memory resources to reduce transformation time and provide real-time or near real-time processing of the inbound request.

2. The method of claim 1 further comprising:
receiving a response to the transmitted request; and
generating a secondary request for transmission to a second node within the software defined network, both the second node and secondary request determined in accordance with the inbound request, the tracked state, and the received response.

3. The method of claim 2 further comprising generating and transmitting an updated response to the inbound request in accordance with the received response.

4. The method of claim 1 wherein the step of generating an outbound request comprises generating a set of outbound requests in accordance with the received inbound request.
